(19) United States
(12) Patent Application Publication
(10) Pub. No.: US 2014/0165342 A1
(43) Pub. Date: Jun. 19, 2014

(54) WRITING IMPLEMENT HOLDER

(71) Applicant: Robert A. Briganti, Los altos, CA (US)

(72) Inventor: Robert A. Briganti, Los altos, CA (US)

(21) Appl. No.: 13/720,997

(22) Filed: Dec. 19, 2012

(51) Int. Cl. F16B 2/22

(52) U.S. Cl. CPC F16B 2/22
USPC 24/542

(57) ABSTRACT

A writing implement holder on a clipboard where the implement is readily accessible to the user on the surface of the clipboard jaw and can be held there while the clipboard is carried stored or handed to another person.

### REFERENCED PROVISIONAL APPLICATIONS

61/627,228 Writing Implement Bolder for Clip Board

61/630,892 Writing Implement Holder With Advertising Space for Clip Board

### FIELD

The field of this invention pertains to clip boards and writing implement holding devices.

### BACKGROUND

Clip boards are used to hold paper or forms etc. so that they can be filled out or written m away from a table or desk providing a fiat hard surface with a dip to heM the paper or form. A writing implement accompanies the clip board vend is sometimes tethered to the board or held under the jaw.

### OBJECT OF INVENTION

This invention allows the storage of a writing implement upon a clipboard jaw where it cm be removed for use and easily replaced in fee stored position, it allows that a clipboard can be carried or handed to anther person without the need to keep track of the writing implement.

### DRAWINGS

FIG. 1 Shows a typical clip board.

FIG. 2 Shows and enlarged view of the clipboard jaw area.

FIG. 3 Shows a side view of the jaw area and how the implement enters the holder.

FIG. 4 Shows a version of the invention where it is formed separately and is attached to the clipboard jaw.

FIG. 5 Shows a shows how the separate version of the invention is positioned on the clip hoard jaw.

FIG. 6 Shows the side view of a separately formed version of the invention.

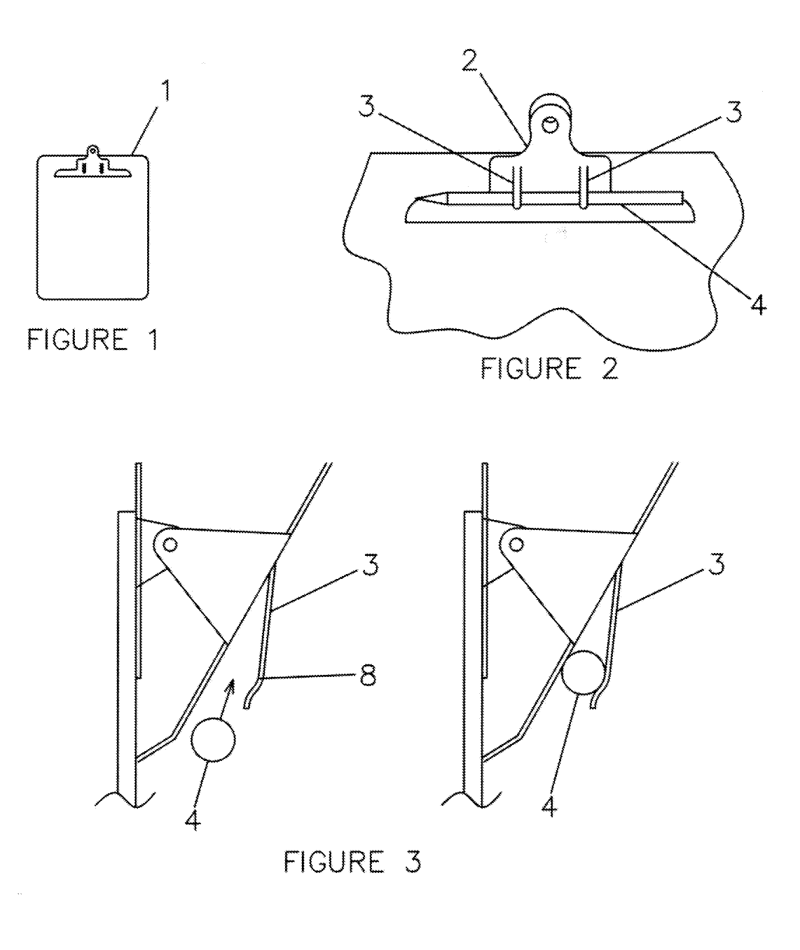

### DESCRIPTION

This invention is a means for removably attaching a writing implement to a clipboard jaw. It is comprised of one or more holding means in the form of a tab or a set of tabs or some other mechanical containment means fashioned to hold the writing implement within detents or between ridges or in a groove, etc. using spring force or other mechanical force for constrainment substantially fixing the writing implement in relation to the clip board. This means may be tabs or arms or fingers or loops etc. The tabs or arms etc can pivot as well and use separate spring elements. The constrainment means can be deformed elastically by manual force moving the implement into an open end of a gap between the constrainment means and the jaw surface. The writing implement may also be held between two sets of constrainment means. These constrainment means are appendages of the clipboard jaw. The implement is then retained in place on the jaw of the clipboard until it is needed. It can be released by applying force to the implement causing elastic deformation of the constrainment means so that the implement can escape the constrainment means. The constrainment means can also utilise a clasp or locking means to maintain constrainment. The device cart also comprise an attachable element achieving part or all of the intended function. This description is intended to provide examples of how someone skilled in the art can fashion a mechanical device wish the utility of removably holding a writing implement in relation to a clipboard and does not limit the scope of the invention.

The preferred embodiment shown in the figures is fabricated by cutting sheet metal or other flat material to the desired shape and formed into the shapes shown, tabs can also be attached separately with spotwelds rivets screws or glue etc. The elements can be formed together or separately and can also be molded in any of the many molding techniques known. It is likely that the easiest way to accomplish this is to include the forming of the constrainment means by modifying the mold or die stamp used to form the jaw.

In FIG. 2 the writing implement 4 is held under tabs 3 formed as part of jaw 2. Tabs 3 are elastic and force placed on implement 4 can deform tab 3 so that implement 4 can move out of or into the stored position.

FIG. 3 shows how implement 4 will be inserted under jaw 3 so that it reaches the trough 7 in jaw 3 where jaw 3 holds implement 4

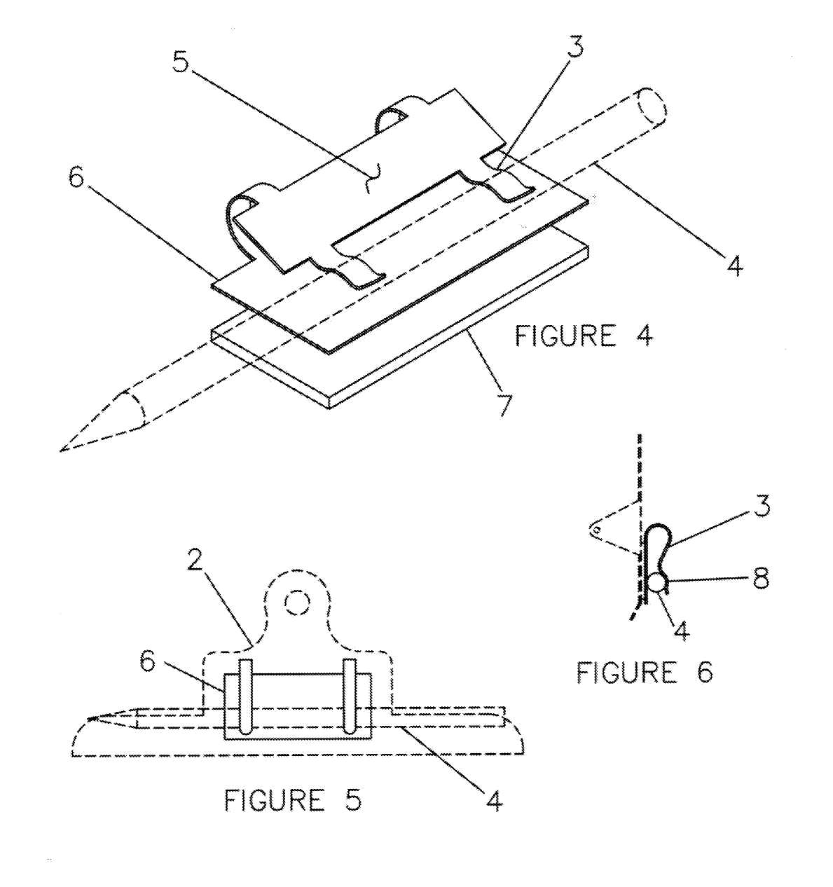

FIG. 4 shows the invention 6 formed separately from the jaw 3 holding implement 4 and also showing an area 5 for ad space or for a logo, decoration etc. It is attached to jaw 4 with the use of doable adhesive tape 7 or other adhesive.

FIG. 5 shows the invention 6 attached to the jaw 3 holding implement 4 resting in trough 8.

I claim:

1. A means for removably attacking a writing implement having a cylindrical outer surface with a circular or polygonal cross section defining a width with regions of this surface referred to as sides along which said attachment means grips comprising a tab or tabs formed to hold said writing implement in a position accessible on a clipboard jaw outer surface between said surface and said tabs whereby said writing implement can be removed using manual force sufficient to deform said tabs to release said implement.

2. Means in claim 1 where said tab tabs are formed separately from said clipboard jaw and are attached to said clipboard jaw outer surface.

3. Means in claim 1 where said tab or tabs hold said writing implement contacting said writing implement said sides over an area wider that said implement width.

4. Said means in claim 1 where said attachment means holds said implement between a pair or pair of appendages.
